(19) United States
(12) Patent Application Publication
(10) Pub. No.: US 2021/0260809 A1
(43) Pub. Date: Aug. 26, 2021

(54) FREE BLOW CONTAINER WITH A PUSH UP BASE

(71) Applicant: Discma AG, Hünenberg (CH)

(72) Inventors: Jessica T. Brown, Ypsilanti, MI (US); Brad Krzyzaniak, Manitou Beach, MI (US); Corey Janes, Hillsdale, MI (US); Darrel Lee, Saline, MI (US)

(21) Appl. No.: 17/255,039

(22) PCT Filed: Jun. 24, 2019
(86) PCT No.: PCT/IB2019/000783

§ 371 Date: Dec. 22, 2020

Related U.S. Application Data
(60) Provisional application No. 62/691,685, filed on Jun. 29, 2018.

(51) Int. Cl. B29C 49/00; B29C 49/46

(52) U.S. Cl. CPC B29C 49/0042; B29L 2031/712; B29C 2049/4664; B29C 49/46

(57) ABSTRACT

An apparatus and method for simultaneously forming and filling a plastic container without the use of a mold forming a mold cavity (116, 16) is provided. A pressure source (120, 20) includes an inlet (146, 150, 46, 50) and a piston-like device (140, 40). The piston-like device (140, 40) is moveable in a first direction wherein liquid is drawn into the pressure source (120, 20) through the inlet (146, 150, 46, 50) and in a second direction wherein the liquid is urged toward the preform (112, 12). A blow nozzle (122, 22) may be adapted to receive the liquid from the pressure source (120, 20) and transfer the liquid at high pressure (P2) into the preform (112, 12) thereby urging the preform (112, 12) to freely expand until an unopened end thereof contacts a platen (118). The platen (118) forms a bottom in a resultant container. The liquid remains within the container as an end product.

### CROSS-REFERENCE TO RELATED APPLICATION

This patent application claims priority to U.S. Provisional Patent Application Ser. No. 62/691,685, filed on Jun. 29, 2018, the entire disclosure of which is hereby incorporated herein by reference.

### FIELD OF THE INVENTION

The present invention relates to a method and apparatus for blow molding a plastic container. More specifically, this disclosure relates to an apparatus and method for simultaneously forming and filling a plastic container during a single manufacturing process.

### BACKGROUND OF THE INVENTION

As a result of environmental and other concerns, plastic containers are now being used more than ever to package numerous commodities previously supplied in glass containers. More specifically, the plastic containers may be formed from polyester, and even more specifically, from polyethylene terephthalate (PET). Manufacturers and fillers, as well as consumers, have recognized that PET containers are lightweight, inexpensive, recyclable, and capable of manufacturing in large quantities.

Blow-molded plastic containers have become commonplace in packaging numerous commodities. PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

% Crystallinity=(ρ−ρₐρ_{c}−ρₐ)×100

where ρ is the density of the PET material; ρₐ is the density of pure amorphous PET material (1.333 g/cc); and ρ_{c} is the density of pure crystalline material (1.455 g/cc). Once a container has been blown, a commodity may be filled into the container.

Traditionally blow molding and filling have developed as two independent processes, in many cases operated by different companies. In order to make bottle filling more cost effective, some fillers have moved blow molding in house, in many cases integrating blow molders directly into their filling lines. The equipment manufacturers have recognized this advantage and are selling “integrated” systems that are designed to ensure that the blow molder and the filler are fully synchronized. Despite the efforts in bringing the two processes closer together, blow molding and filling continue to be two independent, distinct processes. As a result, significant costs may be incurred while performing these two processes separately.

Known methods of simultaneously forming and filling a container are disclosed in commonly-owned U.S. Pat. Nos. 8,573,964, 8,714,963, and 8,858,214, hereby incorporated herein by reference in their entireties. The methods disclosed therein require numerous pieces of equipment including a mold station comprising a pressure source, blow nozzle, stretch rod, and a mold cavity. In a state of emergency or when the rapid filling of containers is otherwise required, moving such equipment nearer to where the filled containers are needed may be difficult and expensive, if not impossible, and such movement is inefficient. Building a mobile blowing station may similarly be cost prohibitive or otherwise inefficient due to the component costs thereof.

Accordingly, it would be desirable to develop a system and method of efficiently simultaneously forming and filling a container wherein a cost and complexity of the same is minimized.

### SUMMARY OF THE INVENTION

Concordant and congruous with the present invention, a system and method of efficiently simultaneously forming and filling a container wherein a cost and complexity of the same is minimized has surprisingly been discovered.

In an embodiment of the invention, a moldless blowing station comprises an armature configured to support a preform, a blow nozzle configured to sealingly engage an opening of the preform and deliver a liquid to an interior of the preform to cause expansion thereof, and a platen disposed in axial alignment with the blow nozzle. The platen defines a bottom surface of a resultant container formed by the expansion of the preform.

According to an embodiment of the invention, a method of simultaneously forming and filling a container comprises locating a preform in the armature of a moldless blowing station; sealably connecting a blow nozzle onto an opening of the preform; accumulating liquid into a chamber; and delivering the liquid from the chamber, through the blow nozzle into the opening of the preform thereby urging the preform to freely expand until a closed end thereof contacts a platen to create a bottom of a resultant container, wherein the liquid remains within the container as an end product; and wherein delivering the liquid from the chamber includes transferring the liquid into the preform at a first pressure and subsequently transferring the liquid into the preform at a second pressure, the second pressure being greater than the first pressure, the first pressure and the second pressure being between approximately 100 PSI and 600 PSI.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a partially schematic cross-sectional depiction of a heated preform passed into a mold station wherein a pressure source including a piston-like device begins to move upward, drawing liquid into the pressure source as known in the art.

FIG. 2 is a partially schematic cross-sectional depiction of the system illustrated in FIG. 1 wherein a stretch rod extends into the preform to initiate mechanical stretching and wherein fluid continues to accumulate in the pressure source.

FIG. 3 is a partially schematic cross-sectional depiction of the system of FIG. 2 wherein the piston-like device drives the liquid from the pressure source to the preform thereby expanding the preform toward the walls of the mold cavity.

FIG. 4 is a partially schematic cross-sectional depiction of the system of FIG. 3 wherein the piston-like device has been fully actuated thereby completely transferring an appropriate volume of liquid to the newly formed container and wherein the stretch rod is withdrawing.

FIG. 5 is a partially schematic cross-sectional depiction of the system of FIG. 4 wherein the mold halves separate and the piston-like device begins to draw liquid into the pressure source in preparation for the next cycle.

FIG. 6 is a partially schematic cross-sectional depiction of a heated preform passed into a moldless blowing station according to an embodiment of the invention.

FIG. 7 is a partially schematic cross-sectional depiction of the system of FIG. 6 wherein the piston-like device drives the liquid from the pressure source to the preform thereby expanding the preform.

FIG. 8 is a partially schematic cross-sectional depiction of the system of FIG. 7 wherein the preform has expanded to an extent wherein a bottom surface thereof contacts and conforms to a shape of a platen disposed below the preform.

FIG. 9 is a front perspective view of a container formed using the system of FIGS. 6-8.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

Biaxially oriented bottles may be manufactured from plastic materials such as polyethylene terephthalate (PET) using both single stage and two-stage machinery. For example, when using the two-stage process, bottles can be manufactured using either of two distinctly different blowing methods. One method of blowing bottles is accomplished by heating preforms from ambient conditions to the lowest possible temperature (but above the glass transition temperature) which will allow for the proper stretching of the material followed by blowing the heated preform into a cold blow mold as rapidly as possible. This process can produce a bottle that has excellent properties for use in many packaging applications, especially for use as a carbonated soft drink bottle. An additional step of conditioning the preform to provide a homogeneous temperature or a temperature distribution across the wall of the preform may be combined with the basic process. The molecular orientation of the material improves the mechanical and optical properties of the ultimately produced container.

This biaxial orientation, however, also increases internal stresses within the container, thereby resulting in dimensional instability under hot conditions. The oriented material has a tendency to shrink, for example during hot filling of a so-produced biaxially oriented container, which relieves the internal stresses but which causes distortion and deformation of the container. This phenomenon is particularly evident when using amorphous polymer preforms which undergo strain induced crystallization during the drawing process, such as for example those made from polyesters, particularly PET.

Biaxially oriented containers which are manufactured for use as bottles for pressurized liquid are conventionally made using a process wherein the preform is blown into conformance with a chilled mold.

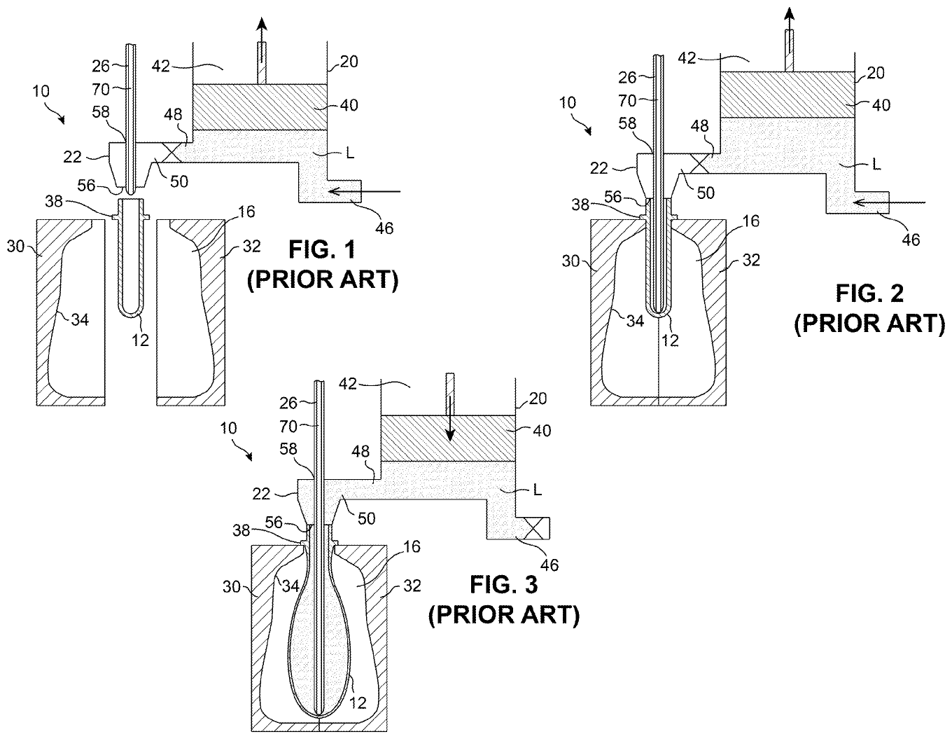

With reference to FIGS. 1-5, a mold station 10 as known in the art is shown. The mold station 10 and associated method utilizing a final liquid commodity L to impart the pressure required to expand a preform 12 to take on the shape of a mold thus simultaneously forming and filling a resultant container C. Known mold stations 10 for simultaneously filling and forming a container C generally includes a mold cavity 16, a pressure source 20, a blow nozzle 22, and a stretch rod 26. The exemplary mold cavity 16 illustrated includes mold halves 30, 32 that cooperate to define an interior surface 34 corresponding to a desired outer profile of a blown container. The mold cavity 16 may be moveable from an open position (see FIG. 1) to a closed position (FIG. 3) such that a support ring 38 of the preform 12 is captured at an upper end of the mold cavity 16. The preform 12 may be formed of a polyester material, such as polyethylene terephthalate (PET), having a shape well known to those skilled in the art similar to a test-tube with a generally cylindrical cross section and a length typically approximately fifty percent (50%) that of the resultant container C height. The support ring 38 may be used to carry or orient the preform 12 through and at various stages of manufacture. For example, the preform 12 may be carried by the support ring 38, the support ring 38 may be used to aid in positioning the preform 12 in the mold cavity 16, or an end consumer may use the support ring 38 to carry the plastic container C once manufactured.

In one example, the pressure source 20 can be in the form of, but not limited to, a filling cylinder, manifold or chamber 42 that generally includes a mechanical piston-like device 40 including, but not limited to, a piston, a pump (such as a hydraulic pump) or any other such similarly suitable device, moveable within the filling cylinder, manifold or chamber 42. The pressure source 20 has an inlet 46 for accepting liquid commodity L and an outlet 48 for delivering the liquid commodity L to the blow nozzle 22. It is appreciated that the inlet 46 and the outlet 48 may have valves incorporated therewith. The piston-like device 40 may be moveable in a first direction (upward as viewed in the figures) to draw liquid commodity L from the inlet 46 into the filling cylinder, manifold, or chamber 42, and in a second direction (downward as viewed in the figures) to deliver the liquid commodity L from the filling cylinder, manifold, or chamber 42 to the blow nozzle 22. The piston-like device 40 can be moveable by any suitable method such as pneumatically, mechanically, or hydraulically, for example. The inlet 46 of the pressure source 20 may be connected, such as by tubing or piping, to a reservoir or container (not shown) which contains the final liquid commodity L. It is appreciated that the pressure source 20 may be configured differently so long as a desired quantity of the liquid commodity L is delivered to the blow nozzle 22 at a desired pressure, as explained in greater detail hereinafter.

The blow nozzle 22 generally defines an inlet 50 for accepting the liquid commodity L from the outlet 48 of the pressure source 20 and an outlet 56 (FIG. 1) for delivering the liquid commodity L into the preform 12. It is appreciated that the outlet 56 may define a shape complementary to the preform 12 near the support ring 38 such that the blow nozzle 22 may easily mate with the preform 12 during the forming/filling process. In one example, the blow nozzle 22 may define an opening 58 for slidably accepting the stretch rod 26 used to initiate mechanical stretching of the preform 12.

In one example, the liquid commodity L may be introduced into the plastic container C during a thermal process, typically a hot-fill process. For hot-fill bottling applications, bottlers generally fill the plastic container C with a liquid or product at an elevated temperature between approximately 185° F. to 205° F. (approximately 85° C. to 96° C.) and seal the plastic container C with a closure (not illustrated) before cooling. In one configuration, the liquid may be continuously circulated within the filling cylinder, manifold, or chamber 42 through the inlet 46 whereby the liquid can be heated to a preset temperature (i.e., at a heat source disposed upstream of the inlet 46). In addition, the plastic container C may be suitable for other high-temperature pasteurization or retort filling processes, or other thermal processes, as desired. In another example, the liquid commodity L may be introduced into the plastic container C under ambient or cold temperatures. Accordingly, by way of example, the plastic container C may be filled at ambient or cold temperatures such as between approximately 32° F. to 90° F. (approximately 0° C. to 32° C.), and more preferably at approximately 40° F. (approximately 4.4° C.).

In use, the mold station 10 is adapted to simultaneously fill and form the plastic container C. At the outset, the preform 12 may be placed into the mold cavity 16. In one example, a machine (not illustrated) places the preform 12 heated to a temperature between approximately 190° F. to 250° F. (approximately 88° C. to 121° C.) into the mold cavity 16. As the preform 12 is located into the mold cavity 16, the piston-like device 40 of the pressure source 20 may begin to draw liquid commodity L into the filling cylinder, manifold, or chamber 42 through the inlet 46. The mold halves 30, 32 of the mold cavity 16 may then close thereby capturing the preform 12. The blow nozzle 22 may form a seal at a finish of the preform 12. The mold cavity 16 may be heated to a temperature between approximately 250° F. to 350° F. (approximately 93° C. to 177° C.) in order to impart increased crystallinity levels within the resultant container C. In another example, the mold cavity 16 may be provided at ambient or cold temperatures between approximately 32° F. to 90° F. (approximately 0° C. to 32° C.). Liquid commodity L may continue to be drawn into the filling cylinder, manifold or chamber 42 by the piston-like device 40.

As shown in FIG. 2, the stretch rod 26 may extend axially into the preform 12 to initiate mechanical stretching. At this point, the liquid commodity L may continue to be drawn into the filling cylinder, manifold, or chamber 42 via continued upward motion of the piston-like device 40. The stretch rod 26 continues to stretch the preform 12, thereby thinning the sidewalls of the preform 12 as the axial length thereof is increased. The volume of liquid commodity L in the filling cylinder, manifold, or chamber 42 may increase until the appropriate volume suitable to form and fill the resultant container C is reached. At this point, a valve disposed at the inlet 46 of the pressure source 20 may be closed.

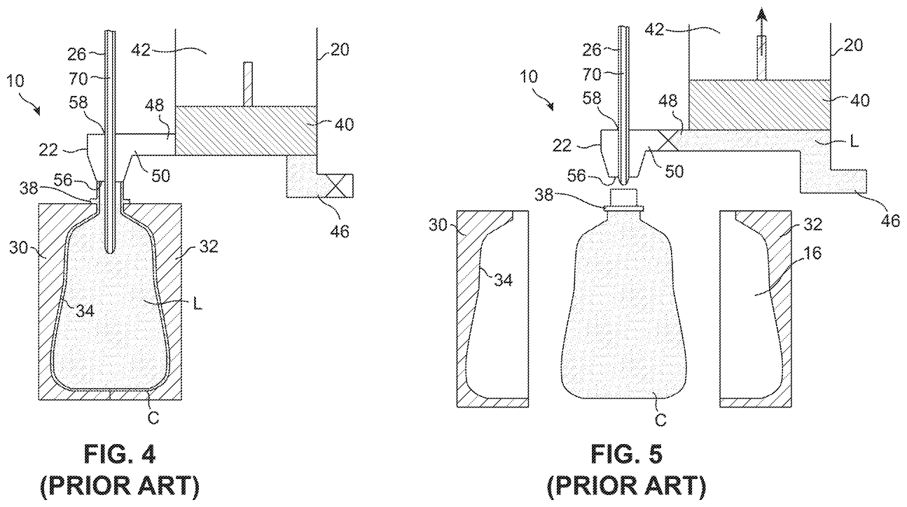

As shown in FIG. 3, the piston-like device 40 may begin to drive downward (drive phase) to initiate the rapid transfer of liquid commodity L from the filling cylinder, manifold, or chamber 42 to the preform 12. Again, the piston-like device 40 may be actuated by any suitable means such as pneumatic, mechanical and/or hydraulic pressure. In one example, the hydraulic pressure within the preform 12 may reach between approximately 100 PSI to 600 PSI. The liquid commodity L causes the preform 12 to expand toward the interior surface 34 of the mold cavity 16. Residual air may be vented through a passage 70 defined in the stretch rod 26 (FIG. 3). As shown in FIG. 4, the piston-like device 40 has completed its drive phase thereby completely transferring the appropriate volume of liquid commodity L to the newly formed plastic container C. Next, the stretch rod 26 may be withdrawn from the mold cavity 16 while continuing to vent residual air. The stretch rod 26 may be designed to displace a predetermined volume of liquid commodity L when it is withdrawn from the mold cavity 16, thereby allowing for the desired fill level of liquid commodity L within the resultant plastic container C. Generally, the desired fill level will correspond to a level at or near the level of the support ring 38 of the plastic container C.

Alternatively, liquid commodity L can be provided at a constant pressure or at different pressures during the molding cycle. For example, during axial stretching of the preform 12, liquid commodity L may be provided at a pressure which is less than the pressure applied when the preform 12 is blown into substantial conformity with the interior surface 34 of the mold cavity 16 defining the final configuration of the plastic container C. This lower pressure P₁ may be ambient or greater than ambient but less than the subsequent high pressure P₂. The preform 12 is axially stretched in the mold cavity 16 to a length approximating the final length of the resultant plastic container C. During or just after stretching the preform 12, the preform 12 is generally expanded radially outward under the low pressure P₁. This low pressure P₁ is preferably in the range of between approximately 100 PSI to 150 PSI. Subsequently, the preform 12 is further expanded under the high pressure P₂ such that the preform 12 contacts the interior surface 34 of the mold halves 30, 32 thereby forming the resultant plastic container C. Preferably, the high pressure P₂ is in the range of approximately 500 PSI to 600 PSI. As a result of the above method, the base and contact ring of the resultant plastic container C is fully circumferentially formed.

Optionally, more than one piston-like device may be employed during the formation of the resultant plastic container C. For example, a primary piston-like device may be used to generate the low pressure P₁ to initially expand the preform 12 while a secondary piston-like device may be used to generate the subsequent high pressure P₂ to further expand the preform 12 such that the preform 12 contacts the interior surface 34 of the mold halves 30, 32, thereby forming the resultant plastic container C.

As shown in FIG. 5, the fill cycle is shown completed. The mold halves 30, 32 may separate and the blow nozzle 22 may be withdrawn. The resultant filled plastic container C is now ready for post-forming steps such as capping, labeling and packing. At this point, the piston-like device 40 may begin the next cycle by drawing liquid commodity L through the inlet 46 of the pressure source 20 in preparation for the next fill/form cycle. While not specifically shown, it is appreciated that the mold station 10 may include a controller for communicating signals to the various components. In this way, components such as, but not limited to, the mold cavity 16, the blow nozzle 22, the stretch rod 26, the piston-like device 40, and various valves may operate according to a signal communicated by the controller. It is also contemplated that the controller may be utilized to adjust various parameters associated with these components according to a given application.

Some additional advantages realized by the present teachings will now be discussed further.

The combination of both the blow and filling processes into one piece of equipment (mold station 10) may reduce handling parts and therefore lead to reduced capital cost per resultant plastic container C. In addition, the space required by a process that simultaneously blows and fills the resultant plastic container C may be significantly reduced over the space required when the processes are separate. This may also result in lower infrastructure cost.

Integrating the two processes into a single step may reduce labor and additional costs (both capital and expense) associated with handling bottles after they are produced and before they are filled.

Integrating the blowing and filling processes into a single process eliminates the need to ship bottles. The shipping of bottles is inherently inefficient and expensive. Shipping preforms, on the other hand, is much more efficient. In one example, a trailer load of empty 500 ml water bottles contains approximately 100,000 individual bottles. The same size trailer loaded with preforms required to make 500 ml water bottles will carry approximately 1,000,000 individual preforms, a 10:1 improvement.

Compressed air is a notoriously inefficient means of transferring energy. Using the final product to provide hydraulic pressure to blow the container will require the equivalent of a positive displacement pump. As a result, it is a much more efficient way to transfer energy.

In the exemplary method described herein, the preforms may be passed through an oven in excess of 212° F. (100° C.) and immediately filled and capped. In this way, the opportunity for an empty container to be exposed to the environment where it might become contaminated is greatly reduced. As a result, the cost and complexity of aseptic filling may be greatly reduced.

In some instances where products are hot filled, the package must be designed to accommodate the elevated temperature that it is exposed to during filling and the resultant internal vacuum it is exposed to as a result of the product cooling. A design that accommodates such conditions may require added container weight. Liquid/hydraulic blow molding offers the potential of eliminating the hot fill process and as a result, lowering the package weight.

The process described herein may eliminate intermediary work in process and therefore may avoid the cost associated with warehousing and/or container silos and/or forklifts and/or product damage, etc. In addition, without work in process inventory, the overall working capital may be reduced.

As blowing and filling are integrated closer but remain as two separate processes (such as conventional methods of forming and subsequently filling), the overall efficiency of such a system is the product of the individual efficiencies of the two parts. The individual efficiencies may be driven largely by the number of transitions as parts move through the machines. Integrating the two processes into one may provide the opportunity to minimize the number of transitions and therefore increase the overall process efficiency.

Many beverages, including juices, teas, beer, etc., are sensitive to oxygen and need to be protected when packaged. Many plastics do not have sufficient barrier characteristics to protect the contents from oxygen during the life of the packaged product. There are a number of techniques used to impart additional barrier properties to the container to slow down oxygen transmission and therefore protect the package contents. One of the most common techniques is to use an oxygen scavenger in the bottle wall. Such a scavenger may be molded directly into the preform. The relatively thick wall of the preform protects the scavenger from being consumed prior to blowing it into a container. However, once the container has been blown, the surface area of the wall increases and the thickness decreases. As such, the path that the oxygen has to travel to contact and react with the active scavenging material is much shorter. Significant consumption of oxygen scavengers may begin as soon as the container is blown. If the container is formed and filled at the same time, then the scavenger is protecting the product through its entire useful life and not being consumed while the container sits empty waiting to be filled.

The method described herein may be particularly useful for filling applications such as isotonic, juice, tea, and other commodities that are susceptible to biological contamination. As such, these commodities are typically filled in a controlled, sterile environment. Commercially, two ways are typically used to achieve the required sterile environment. In Europe, one primary method for filling these types of beverages is in an aseptic filling environment. The filling operation is performed in a clean room. All of the components of the product including the packaging must be sterilized prior to filling. Once filled, the product may be sealed until it is consumed, thereby preventing any potential for the introduction of bacteria. The process is expensive to install and operate. As well, there is always the risk of a bacterial contaminant breaking through the operational defenses and contaminating the product.

In North America, one predominant method for filling contaminant susceptible beverages is through hot filling. In this process, the beverage is introduced to the container at a temperature that will kill any bacteria that is present. The container may be sealed while the product is hot. One drawback to this technology is that the containers usually need to be heavy to sustain the elevated filling temperature and the vacuum that eventually develops in the container as the product cools. As well, the blow process is somewhat more complex and therefore more costly than non-heat set blow molding. The disclosure described herein offers the opportunity to dramatically reduce the cost and complexity of filling sensitive foods and beverages. By combining the blowing and filling processes, there is an ability to heat the preform to over 212° F. (100° C.) for a sufficient period of time necessary to kill any biological contaminants. If a sterile product is used as the container forming medium and then immediately sealed, the process may result in a very inexpensive aseptic filling process with very little opportunity for contamination.

There are many other bottled products where this technology may be applicable. Products such as dairy products, liquor, household cleaners, salad dressings, sauces, spreads, syrups, edible oils, personal care items, and others may be bottled utilizing such methods. Many of these products are currently in blow molded PET containers, but are also in extrusion molded plastic containers, glass bottles, and/or cans. This technology has the potential of dramatically changing the economics of package manufacture and filling.

While much of the description has focused on the production of PET containers, it is contemplated that other polyolefin materials (e.g., polyethylene, polypropylene, etc.) as well as a number of other plastics may be processed using the teachings discussed herein.

While the above description constitutes the present disclosure, it will be appreciated that the disclosure is susceptible to modification, variation, and change without departing from the proper scope and fair meaning of the accompanying claims.

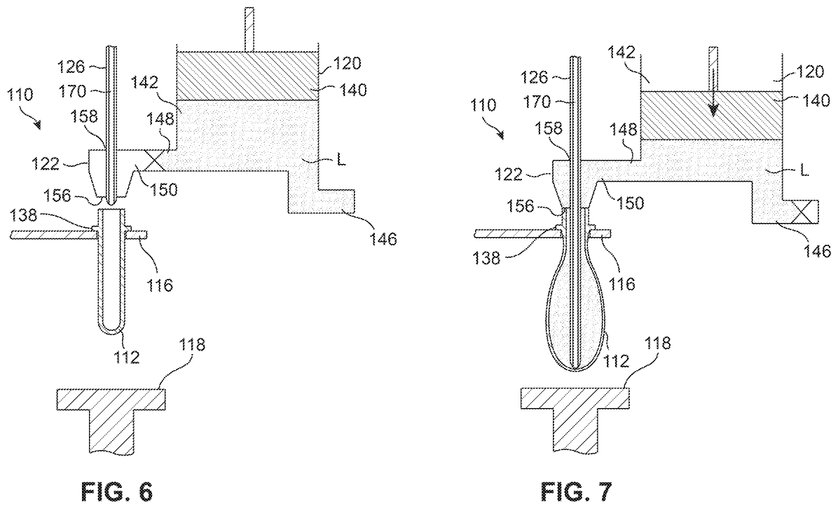

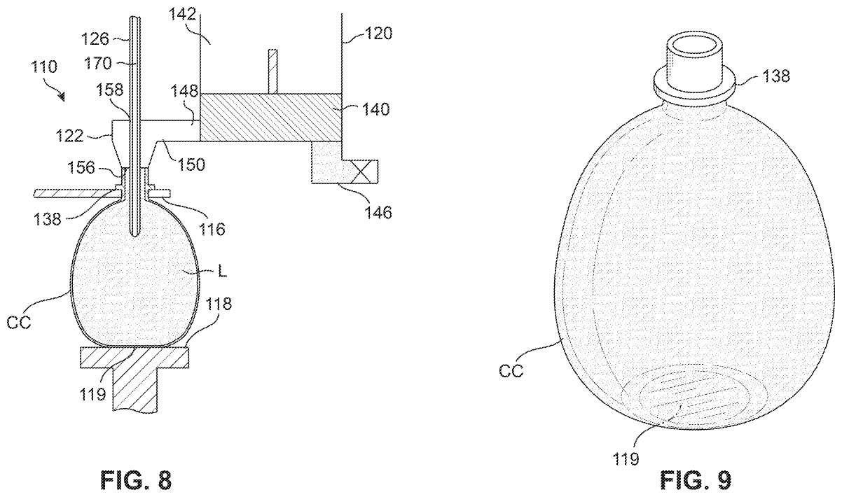

A blowing station 110 is shown in FIGS. 6-8 that is similar in structure and description to the mold station 10 except that the blowing station 110 does not include a mold forming a mold cavity. The moldless blowing station 110 does include a pressure source 120, a blow nozzle 122, and a stretch rod 126. The blowing station 110 further includes an articulable armature 116 or other structure capable of grasping, gripping, holding, or otherwise supporting a support ring 138 of a preform 112. The preform 112 may be formed of a polyester material, such as polyethylene terephthalate (PET), having a shape well known to those skilled in the art similar to a test-tube with a generally cylindrical cross section and a length typically approximately fifty percent (50%) to eighty percent (80%) that of the height of the resultant container CC, as shown in FIGS. 8 and 9. The support ring 138 may be used to carry or orient the preform 112 through and at various stages of manufacture. For example, the preform 112 may be carried by the support ring 138, the support ring 138 may be used to aid in positioning the preform 112 in or on the articulable armature 116, or an end consumer may use the support ring 138 to carry the plastic container CC once manufactured.

In one example, the pressure source 120 can be in the form of, but not limited to, a filling cylinder, manifold, or chamber 142 that generally includes a mechanical piston-like device 140 including, but not limited to, a piston, a pump (such as a hydraulic pump), or any other such similarly suitable device, moveable within the filling cylinder, manifold, or chamber 142. The pressure source 120 has an inlet 146 for accepting liquid commodity L and an outlet 148 for delivering the liquid commodity L to the blow nozzle 122. It is appreciated that the inlet 146 and the outlet 148 may have valves incorporated thereat. The piston-like device 140 may be moveable in a first direction to draw liquid commodity L from the inlet 146 into the filling cylinder, manifold, or chamber 142, and in a second direction to deliver the liquid commodity L from the filling cylinder, manifold, or chamber 142 to the blow nozzle 122. The piston-like device 140 can be moveable by any suitable method such as pneumatically, mechanically, or hydraulically, for example. The inlet 146 of the pressure source 120 may be connected, such as by tubing or piping to a reservoir or container (not shown) which contains the final liquid commodity L. It is appreciated that the pressure source 120 may be configured differently.

The blow nozzle 122 generally defines an inlet 150 for accepting the liquid commodity L from the outlet 148 of the pressure source 120 and an outlet 156 for delivering the liquid commodity L into the preform 112. It is appreciated that the outlet 156 may define a shape complementary to the preform 112 near the support ring 138 such that the blow nozzle 122 may easily mate with the preform 112 during the forming/filling process. In one example, the blow nozzle 122 may define an opening 158 for slidably accepting the stretch rod 126 used to initiate mechanical stretching of the preform 112.

According to an embodiment of the invention, a method of simultaneously forming and filling the plastic container CC will be described. At the outset, the preform 112 may be placed into or onto the armature 116. In one example, a machine (not illustrated) places the preform 112 heated to a temperature between approximately 190° F. to 250° F. (approximately 88° C. to 121° C.) into or onto the armature 116. As the preform 112 is located into or onto the armature 116, the piston-like device 140 of the pressure source 120 may begin to draw liquid commodity L into the filling cylinder, manifold, or chamber 142 through the inlet 146. A platen 118 may then be moved into place adjacent the closed end of the preform 112. The platen 118 is adapted to abut the closed end of the preform 112 as the container CC is formed. The platen 118 may be substantially flat (as shown in FIG. 6), convex, concave, or the platen 118 may have a shape that forms a foot or feet on the container CC as the preform 112 presses thereagainst. Additionally, the platen 118 may be heated or cooled, or may be maintained at an ambient temperature, as desired.

The blow nozzle 122 may form a seal at a finish of the preform 112. Liquid commodity L may continue to be drawn into the filling cylinder, manifold, or chamber 142 by the piston-like device 140.

Next, the stretch rod 126 may extend into the preform 112 to initiate mechanical stretching. At this point, the liquid commodity L may continue to be drawn into the filling cylinder, manifold, or chamber 142. The stretch rod 126 continues to stretch the preform 112 thereby thinning the sidewalls of the preform 112. The stretch rod 126 may extend into the preform 112 until it contacts the platen 118, or the stretch rod 126 may extend only a distance sufficient to provide an initial axial stretch to the preform 112. The volume of liquid commodity L in the filling cylinder, manifold, or chamber 142 may increase until the appropriate volume suitable to form and fill the resultant container CC is reached. At this point, a valve disposed at the inlet 146 of the pressure source 120 may be closed. As shown in FIG. 7, the piston-like device 140 may begin to drive downward (drive phase) to initiate the rapid transfer of liquid commodity L from the filling cylinder, manifold, or chamber 142 to the preform 112. The liquid commodity L causes the preform 112 to expand outwardly. Without a mold or mold cavity in place, the preform 112 is allowed to take a natural shape as dictated by gravity, injection pressure of the liquid, temperature of the preform 112, material properties of the preform 112, extension distance of the stretch rod 126, and other process variables. As the preform 112 expands, the closed end thereof contacts the platen 118 to form a base 119 in the container CC to provide a means by which the container CC can remain upright, as best shown in FIGS. 8 and 9. The platen 118 may be movable to allow for a taller or a shorter container CC to be produced, as desired. As desired, a label (not shown) may be placed on the platen 118 so that during formation of the container CC the preform 112 is disposed on, in, or adjacent to the label such that as the preform 112 expands the label is adhered thereto and formed on the container CC. The label may be designed with a rigidity or from a particular material so as to impart a shape or structure in the container CC as the preform 112 is expanded, as desired.

Residual air may be vented through a passage 170 defined in the stretch rod 126 (FIG. 7). The piston-like device 140 has completed its drive phase thereby completely transferring the appropriate volume of liquid commodity L to the newly formed plastic container C. Next, the stretch rod 126 may be withdrawn from the mold cavity 116 while continuing to vent residual air. The stretch rod 126 may be designed to displace a predetermined volume of liquid commodity L when it is withdrawn from the mold cavity 116 thereby allowing for the desired fill level of liquid commodity L within the resultant plastic container CC. Generally, the desired fill level will correspond at or near the level of the support ring 138 of the plastic container CC. The container CC may be similarly formed from alternative methods as described herein with respect to the container C.

Once the fill cycle is complete, the container CC is fully formed, and the blow nozzle 122 may be withdrawn. The resultant filled plastic container CC is now ready for post-forming steps such as capping, labeling and packing. At this point, the piston-like device 140 may begin the next cycle by drawing liquid commodity L through the inlet 146 of the pressure source 120 in preparation for the next fill/form cycle. While not specifically shown, it is appreciated that the blow station 110 may include a controller for communicating signals to the various components. In this way, components such as, but not limited to, the armature 116, the platen 118, the blow nozzle 122, the stretch rod 126, the piston-like device 140, and various valves may operate according to a signal communicated by the controller. It is also contemplated that the controller may be utilized to adjust various parameters associated with these components according to a given application.

Some additional advantages realized by the present teachings will now be discussed further.

The combination of both the blow and filling processes into one piece of equipment (blowing station 110) may reduce handling parts and therefore lead to reduced capital cost per resultant plastic container CC. Because the blowing station 110 does not include a mold forming mold cavities, capital costs are further reduced, and the complexity of the blowing station 110 is minimized. In addition, the space required by a process that simultaneously blows and fills the resultant plastic container CC may be significantly reduced over the space required when the processes are separate. This may also result in lower infrastructure cost. The space required may be minimized to such an extent that the blowing station 110 may be assembled on a trailer or in a semi truck such that the blowing station 110 is a mobile blowing station 110.

It has been found that the bottle shape obtained with the described blow and filling processes is highly repeatable. In particular, for a given set of process parameters (injection pressure of the liquid, temperature of the preform 112, material properties of the preform 112, extension distance of the stretch rod 126, and other process variables), the shape and size of the resultant container CC is repeatable from one formed container CC to the subsequently formed container. Advantageously, the base 119 formed on the freely blown container CC provides for the container CC that militates against tipping, spilling, and unwanted movement thereof, while providing for low cost, serial production of sealed containers.

Integrating the two processes into a single step may reduce labor and additional costs (both capital and expense) associated with handling bottles after they are produced and before they are filled. Having such a single step process available enabled in a mobile form provides an efficient means in forming containers in emergency situations such as an earthquake or other natural disaster. Having to form containers and fill them and then ship them to a location requires increased cost in handling and may require innumerable shipments of the containers to an area where transportation may be difficult or severely restricted. A mobile blowing station 110 as described herein could be used along with a tank of fluid, e.g., water or the like, and a container(s) of preforms 112 to provide on-site and on-demand containers CC filed with necessary provisions. As noted herein, the shipping of bottles is inherently inefficient and expensive. Shipping preforms, on the other hand, is much more efficient. In one example, a trailer load of empty 500 ml water bottles contains approximately 100,000 individual bottles. The same size trailer loaded with preforms required to make 500 ml water bottles will carry approximately 1,000,000 individual preforms, a 10:1 improvement.

While much of the description has focused on the production of PET containers, it is contemplated that other polyolefin materials (e.g., polyethylene, polypropylene, etc.) as well as a number of other plastics may be processed using the teachings discussed herein.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A moldless blowing station comprising:
an armature configured to support a preform;
a blow nozzle configured to sealingly engage an opening of the preform and deliver a liquid to an interior of the preform to cause expansion thereof; and
a platen disposed in axial alignment with the blow nozzle, the platen defining a bottom surface of a resultant container formed by the expansion of the preform.

2. The moldless blowing station of claim 1, wherein the liquid remains within the resultant container following the expansion of the preform as an end product.

3. The moldless blowing station of claim 1, further comprising a chamber for accumulating the liquid.

4. The moldless blowing station of claim 3, wherein the chamber includes a piston slidably disposed therein, a sliding of the piston in a first direction drawing the liquid into the chamber and sliding of the piston in a second direction delivering the liquid to the blow nozzle.

5. The moldless blowing station of claim 3, wherein the chamber includes a first valve at an inlet thereof and a second valve at an outlet thereof.

6. The moldless blowing station of claim 1, wherein the blow nozzle defines an opening for slidably accepting a stretch rod used to initiate mechanical stretching of the preform prior to the delivering of the liquid into the preform.

7. The method of claim 6, wherein the stretch rod includes an opening for expelling air from the interior of the preform during the delivering of the liquid into the preform.

8. A method of simultaneously forming and filling a container comprising:
locating a preform in an armature of a moldless blowing station;
sealably connecting a blow nozzle onto an opening of the preform;
delivering a liquid through the blow nozzle and into an interior of the preform thereby urging the preform to freely expand until a closed end thereof contacts a platen to create a bottom of a resultant container, the liquid remaining within the container as an end product.

9. The method of claim 8, wherein the delivering of the liquid though the blow nozzle and into the interior of the preform includes accumulating the liquid into a chamber and delivering the liquid from the chamber to the blow nozzle.

10. The method of claim 9, wherein the accumulating of the liquid into the chamber includes a piston slidably disposed within the chamber moving in a first direction to draw the liquid into the chamber and wherein the delivering of the liquid from the chamber to the blow nozzle includes the piston moving in a second direction to expel the liquid from the chamber.

11. The method of claim 9, wherein the chamber includes a first valve at an inlet thereof and a second valve at an outlet thereof.

12. The method of claim 8, wherein the bottom of the resultant container takes on a shape corresponding to a shape of the portion of the platen contacting the closed end of the preform.

13. The method of claim 12, wherein the portion of the platen contacting the closed end of the preform includes at least one of a flat shape, a convex shape, a concave shape, or a shape including a plurality of indentations for forming feet in the bottom of the resultant container.

14. The method of claim 8, wherein the platen is disposed in axial alignment with the blow nozzle during the free expansion of the preform.

15. The method of claim 8, wherein the preform includes a support ring adjacent the opening thereof, the support ring configured to rest on the armature.

16. The method of claim 8, wherein the blow nozzle defines an opening for slidably accepting a stretch rod used to initiate mechanical stretching of the preform prior to the delivering of the liquid into the interior of the preform.

17. The method of claim 16, wherein the stretch rod includes an opening for expelling air from the interior of the preform during the delivering of the liquid into the preform.

18. The method of claim 8, wherein the preform is formed from polyethylene terephthalate (PET).

19. The method of claim 8, wherein the platen in moveable in an axial direction of the blow nozzle to change a height of the resultant container.

20. The method of claim 8, wherein the liquid is delivered to the interior of the preform at a pressure between 100 PSI and 600 PSI.
